(19) United States
(12) Patent Application Publication
(10) Pub. No.: US 2009/0294291 A1
(43) Pub. Date: Dec. 3, 2009

(54) ISO-DIELECTRIC SEPARATION APPARATUS AND METHODS OF USE

(75) Inventors: Joel Voldman, Belmont, MA (US); Michael Vahey, Central Valley, NY (US)

Correspondence Address: RONALD I. EISENSTEIN;NIXON PEABODY LLP, 100 SUMMER STREET, BOSTON, MA, 02110, US

(73) Assignee: MASSACHUSETTS INSTITUTE OF TECHNOLOGY, Cambridge, MA (US)

(21) Appl. No.: 12/093,763

(22) PCT Filed: Nov. 15, 2006
(86) PCT No.: PCT/US06/44304

§ 371 Date: Jul. 21, 2008

Related U.S. Application Data
(60) Provisional application No. 60/737,111, filed on Nov. 15, 2005.

(51) Int. Cl. B01D 57/02; B03C 5/00; B03C 5/02

(52) U.S. Cl. 204/547; 204/643

(57) ABSTRACT

The present invention is directed to an iso-dielectric separation apparatus for separating particles based upon their electrical properties, and methods of using the apparatus.

The application claims benefit under 35 U.S.C. §119(e) of the U.S. provisional application No. 60/737,111, filed Nov. 15, 2005, the content of which is herein incorporated by reference in its entirety.

### FIELD OF THE INVENTION

The present invention is directed to an iso-dielectric separation apparatus for separating particles, including cells, based upon their electrical properties, and methods of using the apparatus.

### BACKGROUND OF THE INVENTION

Separation of cells based upon biological differences is instrumental to work in both fundamental biology and biotechnology. In the former, scientists wishing to use genetic approaches to understand living systems frequently need to isolate a desired cell such as mutant cells from a population and investigate the genetic differences leading to the differing phenotype, a process called screening (1). In biotechnology, one is often interested in engineering certain cells, such as cells expressing useful biomolecules, and wishes to isolate certain cells from the milieu such as those cells creating the highest amount of biomolecule (2, 3). Intrinsic to both of these processes is that one must perturb the genome of the organism and then measure how that perturbation affects the phenotype, which for biotechnological applications may be the amount of biomolecule being produced. The overall ability to study or engineer these organisms is thus fundamentally dependent on our ability to measure. Screening cells for specific biomolecule production typically requires development of a new assay for each biomolecule, even though the separation metric (e.g., production) is the same.

A variety of different approaches to separating cells based upon phenotypic differences has been used. The use of fluorescence activated cell sorting allows separation of live cells, but relies on the use of a label, such as an antibody, to identify different subpopulations of cells for isolation. High performance liquid chromatography is useful for screening proteins and other molecules; however it cannot be used to sort live cells.

One recently developed approach uses electrical differences between cells to separate cells into subpopulations using dielectrophoresis (DEP). Electrodes are used to create an electric field that creates a dipole in a cell. The orientation of the dipole causes the cell to experience a negative DEP force (F_{DEP}) toward the field minimum. The earliest separation approaches were binary, such as separating live from dead yeast by finding conditions where one population would be attracted to electrodes (via positive DEP, p-DEP) and the other population would be repelled (via negative DEP, n-DEP) (6, 9, 10).

Additional DEP-based separation techniques have been described, such as dielectrophoretic field-flow fractionation (DEP-FFF) (11, 12; U.S. 2004/0011651; U.S. 2004/0026250). FFF is a gradient separation technique in which cells first migrate to a unique height in a parallel-plate flow chamber and then are separated based upon those height differences as they flow down the channel. In DEP-FFF, the cells are levitated above a substrate using negative DEP (n-DEP) and migrate to different heights based upon their size and electrical properties. DEP-FFF has been exploited in a variety of mammalian cell separations, such as separating leukocyte subpopulations based upon their dielectric differences (11-15) showing that phenotypic differences can result in electrical differences.

However, DEP-FFF suffers from several fundamental drawbacks. First, it is not a continuous process, meaning that one must inject and separate plugs of cells rather than continuously separating them. This significantly limits throughput and increases the complexity of the system. Second, the separation occurs first out-of-plane in the z-direction and then in the x-direction (the direction of flow). This means that cells must be separated by varying the collection time, which is experimentally tedious and suffers from Taylor dispersion effects that degrade the separation. Finally, because DEP-FFF relies on gravity to produce a counterbalancing downward force, it is difficult to use on small cells such as bacteria, where significant Brownian motion results in unacceptably long settling times.

Accordingly, there is a need for improved methods which allow continuous, high-throughput, real time separation of cell populations.

### SUMMARY OF THE INVENTION

The invention provides a novel iso-dielectric separation (IDS) apparatus, and methods of using this apparatus. The IDS apparatus separates particles, such as cells, based on their electric properties. Particles are introduced into the apparatus by an inlet and encounter a conductivity gradient and an electric field gradient. The electric field carries particles to the point in the conductivity gradient at which the conductivity of the solution is such that electric properties of the particle match those of the solution, their isodielectric point (IDP). At this point, the particles no longer experience an electric force and are able to cross the electrode and continue flowing to the end of the apparatus, where they can be continuously collected into one of several outlets.

One embodiment of the invention provides an IDS apparatus. The IDS apparatus is a fluid flow chamber comprising at least two inlets, a first inlet for introducing particles and a second inlet for introducing fluid into the chamber, at least one outlet for collecting particles and fluid which have transversed the apparatus, and a conductivity gradient and a spatially non-uniform electric field gradient, where the conductivity and electric field gradients increase in the same direction.

The particles are suspended in a solution and introduced into an inlet of the apparatus. A solution with a different conductivity from the particle solution is introduced into a second inlet of the apparatus. The order in which the two solutions are administered is not important. The key is using solutions of different conductivity. To generate the gradient, a mixer, preferably a diffusive mixer, is placed proximal to the entrance of the apparatus and used to mix the two solutions, creating a gradient in the media that goes across the width of the chamber.

To generate the spatially non-uniform electric field gradient, two or more electrodes are placed in the chamber, with one end after the diffusive mixer and the other end near the outlets. The electrodes are aligned at a shallow angle with respect to the flow of fluid through the channel. The electrodes are connected to a power supply to apply a voltage signal to the electrodes, generating an electric field within the flow channel. The electric field is a spatially non-uniform electric field which generates a dielectrophoretic (DEP) force on the particles as they transit the channel. The electric field varies proportionally with the conductivity of the solution.

The apparatus also comprises multiple outlets through which fluid can exit the chamber. As particles transit the chamber, they are dragged to different positions along the width of the chamber depending on their electric properties. When a particle reaches its IDP, the particle no longer experiences a dielectrophoretic force on it, and thus stays at that point along the width. The particle continues flowing to the end of the apparatus, remaining at approximately the same relative width along the chamber. The position long the width of the chamber at which a particle's IDP is reached, allowing its release from the electrode, is also referred to as its release point. Thus, outlets at different positions along the width of the chamber will receive particles with different IDPs. In one embodiment, the apparatus comprises at least two outlets. In one embodiment, the apparatus comprises at least three outlets. In one embodiment, the apparatus comprises four or more outlets.

After the particles reach their IDPs, one can screen for and/or collect particles that have a desired or unknown IDP. Having multiple outlets permits one to make the process continuous and also to screen for unknown IDPs. For example, multiple outlets along the width of the apparatus allows for the continuous collection of fractions which can later be identified or can be further separated by passing the samples through the apparatus again, this time with a different conductivity gradient. In the case where it is desired to collect a cell or plurality of cells with a known IDP, one should ensure that outlets are placed so that at least one outlet is at a position of a desired IDP so that one can collect those particles satisfying that criteria.

In one preferred embodiment, the applied electric field is a negative dielectrophoretic field (n-DEP), the first solution is more conductive than the second solution, and the particles are propelled toward the field minima.

In another preferred embodiment, the electric field is a positive dielectrophoretic field (p-DEP), the first solution is less conductive than the second solution and the particles are propelled toward the field maxima.

The IDS apparatus of the invention can be used to analyze any population of particles with different electric properties. In one embodiment, the particles are screened as they transit the chamber, for example to determine the quantity of such particles or the position of release along the width of the chamber. In another embodiment, the particles separated by their electric properties within the chamber are collected as separate populations, for example, by collection through different outlets.

Another embodiment of the invention provides methods of separating particles with different electric properties using an IDS apparatus. In one preferred embodiment, the particles are cells, and the cells are separated based upon their unique IDPs. Cells may have different IDPs due to a variety of different characteristics, including but not limited to membrane composition, receptors present on the membrane, number of receptors on the membrane surface, expression levels of total protein and/or a particular protein or biolmolecule of interest, presence of mutation, alteration, or modification of a protein of interest, as well as the conductivity of the solution or fluid in which they are suspended.

In one embodiment of the invention, cells have different IDPs due to differences in expressed proteins, including different levels of expression. In one preferred embodiment, the IDS apparatus can be used to collect those cells in a population of cells having a changed level of expression, e.g., expressing higher or lower level of a protein of interest relative to other cells within the same population. In one embodiment, the accumulation of high levels of a protein of interest in a cell decreases the cell's cytoplasmic conductivity and permittivity.

In one embodiment, the invention provides a method for separating cells comprising: (a) introducing a solution containing different cells into a particle sorting apparatus having a fluid flow chamber containing (i) at least a first inlet wherein fluid containing the particles to be separated can be introduced into the chamber; (ii) at least a second inlet wherein a second fluid with a different conductivity than the fluid containing the particles to be separated is introduced into the chamber; (iii) a mixer situated proximal to the first and second inlets, wherein the first and second fluids can be mixed to create a conductivity gradient; (iv) a spatially non-uniform electric field that creates a dielectrophoretic force positioned at an angle with respect to the flow of fluid through the chamber, wherein the dielectrophoretic force varies with fluid conductivity and directs the particles to a position where fluid electrical properties match the electrical properties of the particles, referred to as an isodielectric point (IDP); and (v) outlets for fluid and cells to exit the chamber; wherein the solution containing the cells are introduced into the first inlet; (b) subjecting the cells to the conductivity gradient and spatially non-uniform electric field as the cells traverse the chamber; and (c) screening for cells based upon their IDP as the cells exit the chamber.

In one embodiment, the cells are screened by having outlets at specific positions based upon the IDP of the cells.

In one embodiment, the cells are collected as they exit the particle sorting apparatus.

In one embodiment, the IDP of the cells is known and the cells with the desired IDP are collected as they exit the particle sorting apparatus.

In one embodiment, the IDP of the cells is unknown and cells with varying IDPs are collected as they exit the particle sorting apparatus.

In one embodiment, cells to be screened comprise at least two populations of cells wherein one population of cells is selected based upon having a different IDP than the other population(s) of cells.

In one embodiment, at least two populations of cells have different IDPs due to their expression of higher or lower levels of a particular protein.

In one embodiment, at least two populations of cells have different IDPs due to the presence of a mutation in one protein in one population of cells that is absent in another population.

In one embodiment, the cells are collected in different fractions as they exit the chamber.

In one embodiment, at least one fraction of the collected cells are re-separated via a method comprising: (a) introducing a solution containing the fraction of the collected cells into a particle sorting apparatus having a fluid flow chamber containing (i) at least a first inlet wherein fluid containing the particles to be separated can be introduced into the chamber; (ii) at least a second inlet wherein a second fluid with a different conductivity than the fluid containing the particles to be separated is introduced into the chamber; (iii) a mixer situated proximal to the first and second inlets, wherein the first and second fluids can be mixed to create a conductivity gradient, wherein said conductivity gradient is narrower than the conductivity gradient used in the first separation; (iv) a spatially non-uniform electric field that creates a dielectrophoretic force positioned at an angle with respect to the flow of fluid through the chamber, wherein the dielectrophoretic force varies with fluid conductivity and directs the particles to a position where fluid electrical properties match the electrical properties of the particles, referred to as an isodielectric point (IDP); and (v) outlets for fluid and cells to exit the chamber; wherein the solution containing the cells are introduced into the first inlet; (b) subjecting the cells to the conductivity gradient and spatially non-uniform electric field as the cells traverse the chamber; and (c) screening for cells based upon their IDP as the cells exit the chamber.

In another embodiment of the invention, cells have different IDPs due to different cell types or phenotypes, including but not limited to cancerous and non-cancerous cells, different types of leukocytes, disease versus non disease states and other traits which are known to those of skill in the art to affect cellular electrical properties.

### BRIEF DESCRIPTION OF THE DRAWINGS

FIG. 1 shows an overview of the IDS apparatus of the present invention. A conductivity gradient forms due to diffusion of streams of varying conductivity. A mixed cell population encounters both this conductivity gradient and an electric-field gradient. The electric-field gradient acts as a barrier, pushing the cells to the left, until they reach a solution conductivity that causes the force on them to go to zero. Different particles feel that force at different solution conductivities, and thus the particles separate into bands as shown. These bands flow into different outlets (three are shown) where they are continuously collected.

FIG. 2 shows an overview of dielectrophoresis. Electrodes create an electric field that induces a dipole in a cell. The orientation of the dipole causes the cell to experience a negative DEP force (FDEP) toward the field minimum at top.

FIG. 3 shows a cartoon overview of an IDS apparatus. Different media conductivities are introduced into a diffusive mixer which produces a smoothly varying gradient across the channel's width. Guiding electrodes steer particles along the conductivity gradient until the IDP is reached. Particles with different IDPs are then collected at different outlets.

FIGS. 4A-4B show time-averaged and pseudo-colored images of beads downstream after reaching their IDPs. FIG. 4A shows trial separation of polystyrene beads using NDEP. The smaller, more conductive beads separate out into higher conductivity, as would be expected. The 1.9-μm particles reach their IDP in-frame, where they are seen passing over the electrodes. In FIG. 4B, using pDEP, the smaller beads still separate into higher conductivity, but now this amounts to a further displacement (from left to right) to reach the IDP than that of the larger beads. This demonstrates the sensitivity of the apparatus to differences in particle conductivity, even in the presence of non-trivial size differences; where the separations based on size, the larger particle would move further along the DEP barrier than its smaller counterpart.

FIGS. 5A and 5B shows graphs of the relationship of the CM factor to frequency and media conductivity, respectively. FIG. 5A shows the CM factor of 0%-PHB (blue) and 20%-PHB (green) E. coli as a function of frequency at two different conductivities. At 50 MHz, the 0% (blue) bacteria experience zero force at σm=0.26 S/m, while the 20%-PHB (green) E. coli experience no force at σm=0.14 S/m. FIG. 5B shows that if the frequency is held constant at 50 MHz, the CM factor can be plotted at different media conductivities. In the IDS apparatus, which has a conductivity gradient across the channel, the two particles will separate to different spots.

FIG. 6 shows that conductivity and electric-field must increase together. When the particle is in a region where the conductivity is too high, as shown in A, we want it to go to the right, up the conductivity gradient. Conversely, when the particle is in a region where the conductivity is too high, as shown in B, it should be propelled to the left, down the conductivity gradient. In order for this to occur, the electric-field intensity must increase from left to right, and thus both gradients must increase from left to right.

### DETAILED DESCRIPTION OF THE INVENTION

The invention provides a novel iso-dielectric separation (IDS) apparatus, and methods of using this apparatus to separate particles, such as cells, based on their electrical properties.

One embodiment of the invention provides an IDS apparatus. The IDS apparatus is a fluid flow chamber comprising at least two inlets, a first inlet for introducing particles and fluid, and at least a second inlet for introducing a fluid having a different conductivity than the fluid introduced in the first inlet. The order in which the fluids are administered does not matter. One can also use more than two fluids having different conductivity than the others and introduce particles in more than one fluid solution. There are also at least two outlets for collecting and/or screening separated particles and for egress of fluid and non-relevant fluid which have transversed the apparatus. Within the chamber, there is both a conductivity gradient and a spatially non-uniform electric field gradient, where the conductivity and electric field gradients increase in the same direction.

To generate the conductivity gradient, the particles are suspended in a solution and introduced into an inlet of the apparatus. A solution with a different conductivity from the particle solution is introduced into a second inlet of the apparatus. To generate the gradient, a diffusive mixer, preferably a multi-stage, such as a two-stage or three-stage diffusive mixer is placed at the entrance of the apparatus and used to mix the two solutions, creating a gradient across the width of the chamber.

To generate the spatially non-uniform electric field gradient, two or more electrodes are placed in the chamber, with one end after the diffusive mixer and the other end near the outlets. The electrodes are aligned at a shallow angle with respect to the flow of fluid through the channel. The electrodes are connected to a power supply to apply a voltage signal to the electrodes, generating an electric field within the flow channel. The electric field is a spatially non-uniform electric field which generates a dielectrophoretic (DEP) force on the particles as they transit the channel. The electric field varies proportionally with the conductivity of the solution.

### Dielectrophoresis (DEP)

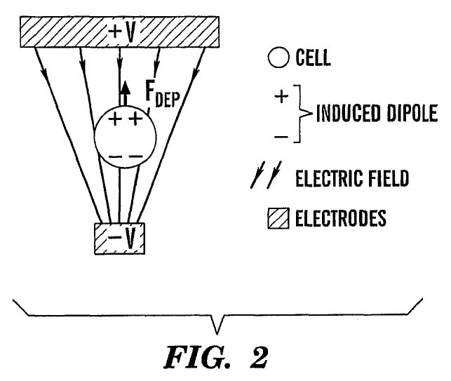

Dielectrophoresis (DEP) refers to the force on a particle in a spatially non-uniform electric field (FIG. 2). It may be analogized to an electrical analogue of optical tweezers and obeys similar physics. Depending on the properties of cell, media, and applied electric field, DEP forces can propel cells toward field maxima (positive DEP or p-DEP) or minima (negative DEP or n-DEP). Dielectrophoresis has been used to viably manipulate and separate many different types of cells, from virus to bacteria to yeast to mammalian cells (4-8). Changing the angle of the field will affect the interaction of the field with the conductivity gradient. The specific angle, field, gradient will vary depending upon one's ultimate objective. This can readily be determined empirically based upon the present disclosure.

The DEP force (F_{DEP}) on a spherical particle is given by formula 1:

F_{DEP}=2πεₘR³Re{CM}·∇E² (1)

Where εₘ is the electrical permittivity of the surrounding media, R is the radius of the particle, and E is the applied electric field. CM is the Clasius-Mossotti (CM) factor, which describes the electrical properties of the particle and the medium, and is given by formula 2:

$$CM = \frac{{\underline{σ}}_{p} - {\underline{σ}}_{m}}{{\underline{σ}}_{p} - 2 {\underline{σ}}_{m}} \qquad ( 2 )$$

where σₚ and σₘ are the complex effective conductivities of the medium and particle. For the medium this is given by formula 3:

σₘ=σₘ+jωεₘ (3)

where σₘ is the conductivity of the medium, εₘ is the permittivity of the medium, ω is the radian frequency, and j is −1. The complex-valued effective conductivity σₘ differs from the actual conductivity σₘ in that the effective conductivity incorporates all the electrical properties of the particle or medium into a single “effective” value that depends on the frequency at which it is measured, whereas the conductivity is a material property of the particle or liquid. For the medium the relation between the two is straightforward. The effective conductivity of cells, however, is a complicated function of their electric properties, such as membrane capacitance and cytoplasmic conductance. Essentially, the effective conductivity is a complex-valued “lumped” view of the conductivity of the particle at some specific frequency. For instance, bacteria are complicated particles with a cell wall, membrane, and cytoplasm. Nonetheless, measuring the conductivity of a particle at one frequency will result in one value—the effective conductivity—that incorporates all the internal structure.

### IDS Apparatus

One embodiment of the invention provides an apparatus to separate particles based on their iso-dielectrophoretic point (IDP). The apparatus comprises a channel through which fluid flows, with several inlets and outlets. As described in detail next, particles are suspended in a solution and introduced into the channel through one inlet. As the particles transit the channel, they separate into distinct positions along the channel's width. Finally, the particles are collected at various outlets at the end of the channel opposite the inlet.

Particles are distinguished by differences in their IDP. As described above, the DEP force on the particle is a function of the effective conductivity and permittivity of the particle itself, the effective conductivity and permittivity and the surrounding solution, and the applied electric field.

The particles are suspended in a solution and introduced into an inlet of the apparatus. A solution with a different conductivity from the particle solution is introduced into a second inlet of the apparatus. To generate the conductive gradient, for example, a two stage diffusive mixer is placed at the entrance of the apparatus and used to alternately split and recombine the two solutions, creating a smoothly varying gradient across the width of the chamber.

To generate the spatially non-uniform electric field gradient, the apparatus has at least two planar electrodes, with one end proximate to the diffusive mixer and the other end proximate to the outlets. The electrodes are aligned at a shallow angle with respect to the flow of fluid through the channel. The electrodes are connected to a power supply to generate an electric field within the flow channel. The electric field is a spatially non-uniform electric field which generates a dielectrophoretic (DEP) force on the particles as they transit the channel. The electric field varies proportionally with the conductivity of the solution.

In one preferred embodiment, the applied electric field is a negative dielectrophoretic field (n-DEP), the particle solution is more conductive than the second solution, and the particles are propelled toward the field minima.

In another preferred embodiment, the electric field is a positive dielectrophoretic field (p-DEP), the particle solution is less conductive than the second solution, and the particles are propelled toward the field maxima.

The apparatus of the invention is a fluid flow channel, sometimes referred to herein as a channel or a chamber, typically a thin, enclosed chamber. The channel can have at least two inlet ports and one outlet port, sometimes referred to as simply inlets and outlets. The ports may take the form of drilled holes on the major walls of the chamber at positions close to the chamber inlet end. In addition to the at least two inlet ports, the chamber may also include one or more input ducts which allow the fluid to flow through the apparatus.

The inlet ports allow the introduction of matter, including solutions and particles suspended in solutions, into the chamber. The inlet ports include at least one inlet for the introduction of the particles suspended in the particle fluid, and a second inlet for the introduction of a second fluid. The conductivity of the first particle fluid is different from the conductivity of the second fluid. Fluids are sometimes referred to herein as media or solutions.

The inlet ports may be coupled to any adaptors, such as tubing, which facilitate the introduction of fluid into the chamber. The particles can be suspended or solubilized in a liquid medium or fluid, sometimes referred to herein as the particle fluid or particle solution. The particle fluid and second fluid, sometimes referred to simply as the fluids, can be introduced into the chamber using means. In one embodiment, the fluid can be introduced through an injection valve equipped with an injection loop. The use of such injection valves for introducing fluids is known to those skilled in the art, as typically employed in chromatography. See, for example, Wang et al.; Biophys. J.; 74:2689-2701 (1998).

The apparatus of the invention comprises a mixer proximate to the inlet ports. The mixer alternately splits and recombines the input fluids to create a conductivity gradient along the width of the chamber. Any mixer which can be accommodated in the fluid flow chamber can be used. The mixer may be any device known to those of skill in the art that functions to create a gradient along the width of the chamber. For example, a chaotic mixer or electrokinetic instability micromixing may be used (see for example, Science, 2002 Jan. 25:295(5555):647-51 and Anal Chem. 2001 Dec. 15:73(24):5822-32, respectively). In one embodiment, the mixer is a multiple-stage mixer. In a preferred embodiment the mixer is a diffusive mixer.

The outlet port of the chamber according to the present invention may take many forms. Specifically, the outlet port, sometimes referred to herein as simply the outlet or the port, may be a single outlet, or a plurality of outlets, or an array of outlets. Because the particles to be analyzed reach different positions in the chamber along the chamber's width, the chamber can have a plurality of different outlets at different positions along the chambers width, allowing the particles to exit the chamber so that the particles can be collected and analyzed.

The design and method of using the IDS apparatus of the invention allow the continuous operation of the apparatus and separation of particles. The particles can be continuously introduced into the chamber through the inlet port, along with the second fluid. Upon their introduction into the chamber, the particles experience dielectrophoretic forces and conductivity gradient and are directed towards to different release points within the chamber, corresponding to different positions along the width of the chamber. As described above, a particle's IDP is reached at its release point, and all the forces acting on the particles balance each other and the net force on the particles become zero. Once the particles reach their release point, they are released from the force exerted by the guiding electrode and are moved by the fluid flow to the end of the chamber, approximately maintaining the same position along the width of the chamber. The flow velocity profile would carry the matter through the chamber. Depending on their release points along the width of the chamber, particles exit the chamber at different positions. Outlets can be designed and positioned to be present in the desired number and at the desired positions to collect particles with different release points.

In one embodiment, the particles are not separately collected as they exit the chamber, but instead are screened to determine their release point. For example, the particles may be fluorescently labeled. In such a screening embodiment, the IDS apparatus may comprise a single outlet port for example which may be located along the entire width or a part of the width of the chamber.

The outlet port may be adapted to receive particles of various shapes and sizes. For example, the size of the outlet port may vary from approximately twice the size of the particles to be collected to the entire width of the chamber. In one embodiment, the outlet port may be constructed of one or more tubing elements, such as TEFLON® tubing. The tubing elements may be combined to provide an outlet port having a cross section comprised of individual tubing elements. Further, for example, the outlet port may be connected to fraction collectors or collection wells which are used to collect separated matter. As used herein, “fraction collectors” and “collection wells” include storage and collection devices for discretely retaining the discriminated particulate matter and solubilized matter. Other components that may be included in the apparatus of the present invention are, for example, measurement or diagnostic equipment, such as flow cytometers, lasers, particle counters, particle impedance sensors, impedance analyzers, and spectrometers. These analytical instruments connected directly to the outlet port of the chamber may serve not only detection step for measuring and recording the time of the arrival of the particulate or solubilized matter but also analyzing step for characterizing the properties of the matter. For example, an AC impedance sensor may be connected to the outlet port of the chamber, and coupled with AC impedance sensing electronics, may serve an analytical step for determining the AC impedance of individual particles when they exit the separation chamber.

In an illustrative embodiment, the chamber can be constructed in a rectangular shape. The chamber walls may be spaced apart by spacers to create the rectangular design. The chamber can be made of, for example, glass, polymeric material such as TEFLON®, or any other suitable material. Other shapes are possible depending upon the goal of the particles being analyzed and/or collected.

The size and dimensions of the chamber can be designed to allow the effective separation of the particles to be analyzed, including reflecting the size of the particles which are to be separated. In one embodiment, the apparatus can be between about 100 nm and about 10 mm wide. In one embodiment, the chamber can be about 0.5 mm wide. In one embodiment, the chamber can be about 1.0 mm wide. In one embodiment, the chamber can be about 2.8 mm wide. In one embodiment, the chamber can be between about 20 microns and about 600 microns wide, for example, for the purpose of analyzing mammalian cells.

In one embodiment, the chamber can be between about 100 nM and 10 mm long. In one embodiment, the chamber can be about 0.5 cm long. In one embodiment, the chamber can be about 1.0 cm long. In one embodiment, the chamber can be about 1.5 cm long. A longer chamber may be desired to permit greater analysis throughput.

An apparatus according to the present invention can analyze particles at a rate between about 100 and about 3 million particles per second. Factors that determine the analysis rate include, for example, the dielectric properties of the particles, the electrode design, length of the chamber, fluid flow rate, frequency and voltage of the electrical signals, and the signal waveforms. The chamber dimensions may be chosen to be appropriate for the input matter type, characteristics, and degree of analysis desired or required.

Fluid flow rates through the chamber can be optimized for the particles to be analyzed. In one embodiment, the flow rate is about 0.25 micro liters per minute. In one embodiment, the flow rate is about 0.5 micro liters per minute. In one embodiment, the flow rate is about 1 micro liters per minute. In one embodiment, the flow rate is about 2 micro liters per minute. In one embodiment, the flow rate is about 4 micro liters per minute.

In a typical design embodiment, the bottom surface of the chamber contains at least two planar electrodes. The electrodes can be a microelectrode array of, for example, parallel electrode (interdigitated) elements. In certain embodiments, the parallel electrode elements may be spaced about 20 microns apart. The apparatus may accommodate electrode element widths of between about 0.1 microns and about 1000 microns, and more preferably between about 1 micron and about 100 microns for embodiments for the analysis of cellular matter. Further, electrode element spacing may be between about 0.1 microns and about 1000 microns, and for cellular discrimination more preferably between about 1 micron and about 100 microns. Alteration of the ratio of electrode width to electrode spacing in the parallel electrode design changes the magnitude of the dielectrophoretic force and thereby changes the particle levitation characteristics of the design.

The electrode elements may be connected to a common electrical conductor, which may be a single electrode bus carrying an electrical signal from the signal generator to the electrode elements. Alternately, electrical signals may be applied by more than one bus which provides the same or different electrical signals. In certain embodiments, alternate electrode elements may be connected to different electrode buses along the two opposite long edges of the electrode array. In this configuration, alternate electrode elements are capable of delivering signals of different characteristics. As used herein, “alternate electrode elements” may include every other element of an array, or another such repeating selection of elements. The electrode elements may be fabricated using standard microlithography techniques that are well known in the art. For example, the electrode array may be fabricated by ion beam lithography, ion beam etching, laser ablation, printing, or electrode position. The array may be comprised of for example, a 100 nm gold layer over a seed layer of 10 nm chromium or titanium.

An apparatus according to the present invention may be used with various methods of the present invention. For example, an apparatus according to the present invention may be used in a method of analyzing particles. This method includes the following steps.

The chamber includes at least two electrode element adapted along the bottom wall of the chamber. These electrode elements may be electrically connected to an electrical conductor, which in turn is connected to an electrical signal source. In the discussion which follows, the terms “electrode element” or “electrodes” will be used. As used herein, “electrode element” is a structure of highly electrically-conductive material over which an applied electrical signal voltage is constant. It is to be understood that these terms include all of the electrode configurations described below. An electrical signal generator, which may be capable of varying voltage, frequency, phase or all the three may provide at least one electrical signal to the electrode elements. The electrode elements of the present invention may include, for example, a plurality of electrode elements which may be connected to a plurality of electrical conductors, which in turn are connected to the electric signal generator.

The chamber according to the present invention may include a plurality of electrode elements which comprise an electrode array. As used herein, an “electrode array” is a collection of more than one electrode element in which each individual element may be displaced in a well-defined geometrical relationship with respect to one another. This array may be, for example, an interdigitated (or parallel) array, interdigitated castellated array, a polynomial array, plane electrode, or the like. Further, the array may be comprised of microelectrodes of a given size and shape, such as an interdigitated array. The electrode array may be adapted along the bottom or wall of the chamber. Alternately, it is envisioned that the electrode array may be incorporated into the material which comprises the chamber walls. In certain embodiments, the electrode array may be a multilayer array in which conducting layers may be interspersed between insulating layers. Fabrication of such an electrode array, depending on electrode dimensions, may use any of the standard techniques known in the art for patterning and manufacturing microscale structures. The apparatus of the present invention, including its electrode(s), can be fabricated using standard techniques known in the art for patterning and manufacturing microscale structures. Electrode arrays for use in the fluid flows chambers of the invention may be made by microlithography as is known in the art. Microfabrication has been utilized to make electrode arrays for cell manipulation since the late 1980s. Photomasks for use in the device fabrication can be created using standard mask layout software. The use of silicon and glass and micromachining methods may be used for cases where integrated electronics and sensor capabilities are required that other fabrication methods cannot provide. In other cases, a combination of flat glass and injection-molded polymers may be used to fabricate the devices disclosed herein by methods known in the art. Small devices may be made by silicon and glass micromachining, and can be reproduced by single layer lithography on a flat glass substrate (for the electrodes) with all fluidic channels molded into a top, for example a clear polydimethylsiloxane (PDMS) top.

For an interdigitated (parallel) array, the parallel electrode elements may be adapted to be substantially at a shallow angle with respect to the length to the chamber. It is also possible to use a three-dimensional electrode element that may or may not be attached to the surface of the chamber. For example, electrode elements may be fabricated from silicon wafers, using the semiconductor microfabrication techniques known in the art. If the electrodes are adapted along the exterior surface of the chamber, it is envisioned that a means of transmitting energy into the chamber, such as a microwave transmitter may be present. The electrode elements may be configured to be on a plane substantially normal or parallel to a flow of fluid traveling through said chamber. However, it is to be understood that the electrode elements may be configured at many different planes and angles to achieve the benefits of the present invention.

When the electrode elements are energized by at least one electrical signal from the electrical signal generator, the electrode elements thereby create spatially non-uniform alternating electric field, which causes a DEP force on the particles. Depending on the properties of the particle, the fluid, and the applied electric field, the DEP forces can propel particles toward field maxima, referred to as positive DEP or p-DEP, or toward field minima, referred to as negative or DEP or n-DEP. In reference to the fluid traveling through the chamber, the DEP force may act substantially in a direction normal to the fluid flow. As used herein, “a direction normal to the fluid flow” means in a direction which is substantially non-opposing and substantially nonlinear to the flow of a fluid traveling through the chamber. This direction may be for example, vertically, sideways, or in another non-opposing direction. By effect of this DEP force, particles are displaced to different positions within the fluid, in particular within the flow velocity profile established in the chamber. This displacement may be relative to the electrode elements, or may relate to other references, such as the chamber walls. Typically, reference is made to a particles' position with respect to the width of the chamber.

In the present invention, the DEP force is dependent on the magnitude of the spatial non-uniformity of the electric field and the in-phase part of the electrical polarization induced in matter by the field. It is to be understood that the term “electrical polarization” is related to the well-known Clausius-Mossotti factor. This field-induced electrical polarization is dependent on the differences between the dielectric properties between the particles and the suspending fluid. These dielectric properties include dielectric permittivity and electrical conductivity. Together, these two properties are known as complex permittivity. The DEP force causes the matter to move towards or away from regions of high electrical field strength, which in an exemplary embodiment, may be towards or away from the electrode plane.

Common electrical conductors may be used to connect the electrodes to the signal generator. The common electrical conductors may be fabricated by the same process as the electrodes, or may be one or more conducting assemblies, such as a ribbon conductor, metallized ribbon or metallized plastic. A microwave assembly may also be used to transmit signals to the electrode elements from the signal generator. All of the electrode elements may be connected so as to receive the same signal from the generator. It is envisioned that such a configuration may require presence of a ground plane. More typically, alternating electrodes along an array may be connected so as to receive different signals from the generator. The electrical generator may be capable of generating signals of varying voltage, frequency and phase and may be, for example, a function generator, such as a Hewlett Packard generator Model No. 8116A. Signals desired for the methods of the present invention are in the range of about 0 to about 50 volts, and about 0.1 kHz to about 100 MHz, and more preferably between about 0 to about 15 volts, and about 10 kHz to 10 MHz. These frequencies are exemplary only, as the frequency required for separating particles is dependent upon the conductivity of for example, the suspension fluid. Further, the desired frequency is dependent upon the characteristics of the particles to be analyzed. The variation of the frequency will generally alter the polarization factor (the Clausius-Mossotti factor) of the matter and change the DEP forces exerted on the matter. Thus to enhance the discrimination of matters using the present invention, the operational frequency may be chosen so as to maximize the difference in the DEP forces exerting on the matter or maximize the difference in the DEP-force induced levitation height between different matter.

The separation of particles depends also on the shape, size and configuration of the electrode elements. The change in these variables may significantly alter electrical field distribution and affect DEP forces acting on particles. Thus, it may be necessary to design different geometries of electrodes for different applications of the present invention. Electrodes may be, for example, an interdigitated (or parallel) array, interdigitated castellated array, a polynomial array, plane electrode, or the like. Further, the array may be comprised of microelectrodes of a given size and shape, such as an interdigitated array.

In an exemplary embodiment, the signals are sinusoidal, however it is possible to use signals of any periodic or aperiodic waveform. The electrical signals may be developed in one or more electrical signal generators which may be capable of varying voltage, frequency and phase. Furthermore, DEP forces acting on matters may be programmed and varied by electrical signals applied to electrode arrays so that the signal amplitude, frequency, waveforms, and/or phases are a function of the time. For example, the applied sinusoidal signal may have a frequency (f.sub.1) for certain-length of time and may then be changed to a frequency (f.sub.2). Alternatively, electrical signals with frequency-modulation (frequency continuously changes with time) and amplitude-modulation (amplitude continuously changes with time) may be applied. The signals applied to electrode arrays can therefore be programmed according to the specific separation goals and the specific separation problems. By employing such programmed signals, the DEP force may be varied with time for enhancing separation performance and the IDS apparatus may be tailored to specific applications.

### Particles for Separation

The methods according to the present invention may be used to analyze any particles. In one embodiment, the methods of the present invention may also be used to discriminate biological matter, such as cells, cell organelles, cell aggregates, nucleic acids, bacterium, protozoans, or viruses. Further, the particles may be, for example, a mixture of cell types, such as cells expressing high levels of a protein in a mixture of cells expressing a range of levels. Other examples include fetal nucleated red blood cells in a mixture of maternal blood, cancer cells such as cancer cells in a mixture with normal cells, or cells infested with an infectious agent. Additionally, the methods of the present invention may be used to discriminate solubilized matter such as a molecule, or molecular aggregate, for example, proteins, or nucleic acids.

Particles to be analyzed using the IDS apparatus of the invention discriminated may be any size. However, the present invention is generally practical for particles between about 10 nm and about 1 mm, and may include, for example, chemical or biological molecules (including proteins, DNA and RNA), assemblages of molecules, viruses, plasmids, bacteria, cells or cell aggregates, protozoans, embryos or other small organisms, as well as non-biological molecules, assemblages thereof, minerals, crystals, colloidal, conductive, semiconductive or insulating particles and gas bubbles. For biological applications using living cells, the present invention allows cells to be separated without the need to alter them with ligands, stains, antibodies or other means. Cells remain undamaged, unaltered and viable during and following separation. Non-biological applications similarly require no such alteration. It is recognized however, that the apparatus and methods according to the present invention are equally suitable for separating such biological matter even if they have been so altered.

### Applications

The IDS apparatus of the present invention has a wide variety of applications. One preferred embodiment provides for separating cells during bioprocess engineering. When producing compounds biologically, whether they are therapeutics (small molecules, antibodies, etc.), vitamins, polymers, etc., at some point the cell must be optimized to produce the greatest amount of compound. For prokaryotic and eukaryotic expression systems where the cell retains the produced molecule rather than secreting it, higher producing cells accumulate more biomolecule, resulting in altered cytoplasmic electrical properties which allows their analysis and separation using the IDS apparatus of the present invention.

The invention will be further characterized by the following examples which are intended to be exemplary of the invention.

### EXAMPLE

### Iso-Dielectric Separation Microdevice for Separating Cells Based Upon Electrical Properties

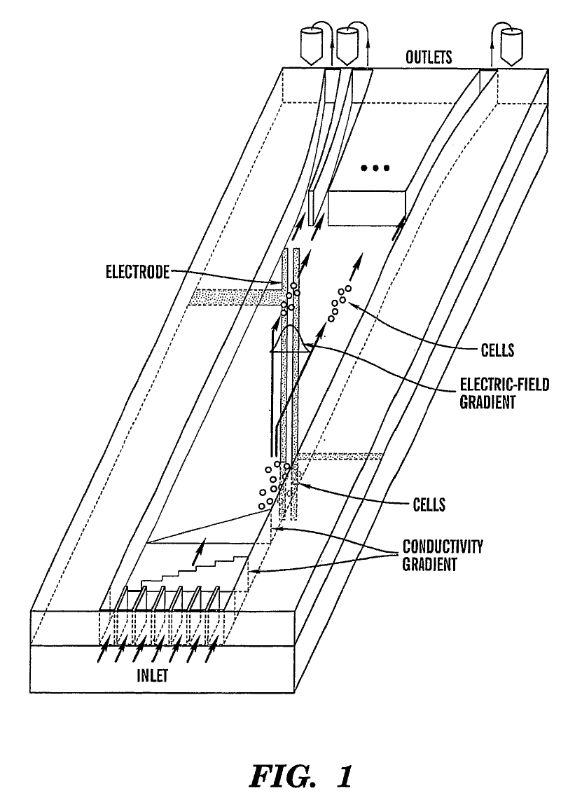

We describe a new generic approach for separating cells based upon biomolecule production that is high-throughput, continuous, and real-time (FIG. 1). This approach exploits the differences in electrical properties that exist between cells producing different amounts of biomolecule. Our hypothesis is that accumulating significant amounts of biomolecules will decrease cytoplasmic conductivity and permittivity. As described below, our approach involves creating co-linear gradients of electric-field intensity and liquid conductivity, which causes cells to separate where their electrical properties match that of the liquid, similar to iso-electric focusing, but using conductivity instead of charge and dielectrophoresis instead of electrophoresis. We thus call this approach iso-dielectric separation (IDS).

Dielectrophoresis (DEP) refers to the force on a particle in a spatially non-uniform electric field (FIG. 2). It is essentially an electrical analogue of optical tweezers and obeys similar physics. Depending on the properties of cell, media, and applied electric field, DEP forces can propel cells toward field maxima (positive DEP or p-DEP) or minima (negative DEP or n-DEP). Dielectrophoresis has been used by our group (4-6) and others (7, 8) to viably manipulate and separate many different types of cells, from virus to bacteria to yeast to mammalian cells.

The DEP force (FDEP) on a spherical particle is given by formula 1:

F_{DEP}=2πεₘR³Re{CM}·∇E² (1)

Where εₘ is the electrical permittivity of the surrounding media, R is the radius of the particle, and E is the applied electric field. CM is the Clasius-Mossotti (CM) factor, which describes the electrical properties of the particle and the medium, and is given by formula 2:

$$CM = \frac{{\underline{σ}}_{p} - {\underline{σ}}_{m}}{{\underline{σ}}_{p} - 2 {\underline{σ}}_{m}} \qquad ( 2 )$$

where σₚ and σₘ are the complex effective conductivities of the medium and particle. For the medium this is given by formula 3:

σₘ=σₘ+jωεₘ (3)

where σₘ is the conductivity of the medium, εₘ is the permittivity of the medium, ω is the radian frequency, and j is −1. We emphasize that the complex-valued effective conductivity σₘ differs from the actual conductivity σₘ in that the effective conductivity incorporates all the electrical properties of the particle or medium into a single “effective” value that depends on the frequency at which it is measured, whereas the conductivity is a material property of the particle or liquid. For the medium the relation between the two is straightforward. The effective conductivity of cells, however, is a complicated function of their electric properties, such as membrane capacitance and cytoplasmic conductance. Essentially, the effective conductivity is a complex-valued “lumped” view of the conductivity of the particle at some specific frequency. For instance, bacteria are complicated particles with a cell wall, membrane, and cytoplasm. Nonetheless, measuring the conductivity of the bacteria at one frequency will result in one value—the effective conductivity—that incorporates all the internal structure.

Description of Technology

Iso-dielectric separation (IDS) separates cells using a continuous, in-plane technique which is non-destructive and comparably robust against variations in particle size. Our conception of iso-dielectric separation relies fundamentally on the creation of a conductivity gradient and a proportional gradient in electric field intensity. At appropriate frequencies, this combination of collinear field and conductivity results in a net force directing the particle to the region in the channel where the media conductivity matches that of the particle: the iso-dielectric point (IDP). By establishing a linear conductivity gradient, we are able to map a particle's spatial location along this gradient with its IDP, and do so in such a way that a continuum of particle conductivities are resolvable. This separation method is enabled primarily by microfabrication; our leveraging of microtechnology enables us to create strong electric fields at relatively low voltages, as well as control the effects of ion diffusion.

Apparatus Operation

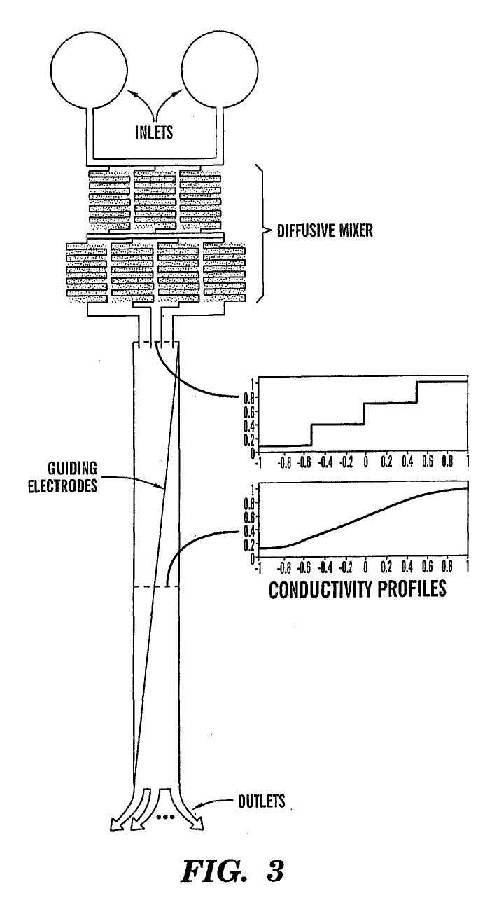

FIG. 3 depicts a schematic of our apparatus, highlighting its essential components. The method of operation is summarized as follows. First, the particles to be separated are suspended in media of the desired conductivity and injected into one of the apparatus's two inlets. Media with a different conductivity (either higher or lower, depending on the intended mode of operation) is injected through the second inlet. The two fluids are then alternately split and recombined in a two-stage diffusive mixer. This produces a staircase conductivity gradient at the entrance to the separation flow chamber, which is quickly smoothed into a linear shape by diffusion. Given a smoothly varying conductivity gradient across the width of the channel, the particles may now be separated. The fundamental principle by which iso-dielectric separation works is the dependence of the DEP force on the relative conductivity and permittivity of the particle and the surrounding media. Our implementation of an IDS apparatus acts essentially as a conductivity-selective barrier. Planar strips of electrodes are arranged at a shallow angle with respect to the flow. These electrodes produce a spatially non-uniform electric field that, as calculated by finite-element methods, is nearly symmetric around the electrodes. This near symmetry is a consequence of the localization of the electric fields; because the electrode spacing is much less than the channel width, the change in conductivity over the region in which the electric field is nonvanishing is, to first order, negligible. The result is a region in which the electric field varies proportionally with media conductivity, regardless of the direction in which the conductivity increases or decreases. Because the shape of the electric field is reasonably insensitive to the global characteristics of the conductivity gradient, IDS can be performed under either of two modes of operation, depending on the properties of the particles to be separated. These modes are identified by whether the barrier potential created by the DEP force acting on the particle is attractive (p-DEP) or repulsive (n-DEP). These are discussed below.

n-DEP Operation

Particles are injected into the apparatus in high conductivity media while less conductive media is introduced through a second, separate inlet. A diffusive mixer is used to produce a smoothly varying conductivity gradient in the main flow chamber. Because the particles are suspended in media with higher conductivity than the particles themselves, they are pushed in the direction of decreasing electric-field intensity, opposite the direction of flow. The geometric asymmetry of this n-DEP barrier guides the particles across the width of the channel, in the direction of decreasing media conductivity. The frequency at which the electrodes are actuated is selected such that as media conductivity decreases, the DEP force goes to zero. Importantly, for any particle of finite conductivity (i.e. neither perfectly insulating nor perfectly conducting), such a frequency is guaranteed to exist for some appropriately conductive or insulating media. Thus by varying the operating frequency and the range of media conductivities across the channel, one may control the spatial location of a particle's IDP, the point at which fluidic drag overwhelms the DEP barrier and the particle is separated out. In this way, particle conductivity is mapped to a position along the channel width at the outlet of the flow chamber.

p-DEP Operation

The principle of operation is identical with the n-DEP case described above—fluid drag and DEP forces are balanced until the IDP of a particle is reached—except that the direction of the conductivity gradient is reversed. Particles suspended in relatively insulating media will undergo p-DEP. As with the n-DEP case, the left-right asymmetry of the electrodes will force the particles to traverse the width of the chamber, through increasingly conductive media. Choosing the frequency and conductivity range appropriately assures that the IDP of a particle will be reached prior to traveling the entire width of the channel. As a result, conductivity differences between particles are recast as differences in the particles' positions at the outlet of the channel. Note that both modes of operation are predicated on the ability to balance drag and DEP forces for flow rates at which the conductivity gradient will not substantially attenuate by diffusion. They also exemplify the necessary conditions for IDS, as we have defined it: creation of spatially varying dielectric properties in a microfluidic apparatus, use of DEP as a transduction mechanism of dielectric properties to force, and use of left-right asymmetric designs to translate force into position along a single, one-dimensional axis (the channel's width).

Characterization

Preliminary results demonstrating the feasibility of IDS have been obtained using both NDEP and pDEP. To characterize the device, we use polystyrene microspheres as test particles. While bulk polystyrene is itself rather insulating, charge groups on the surface of these particles induce a conductive double layer that can significantly modify the effective “lumped” conductivity of the particle. The effect of surface conductance on particle conductivity is adequately described by formula 4:

$$σ = {σ}_{bulk} + \frac{2 {K}_{S}}{R} \qquad ( 4 )$$

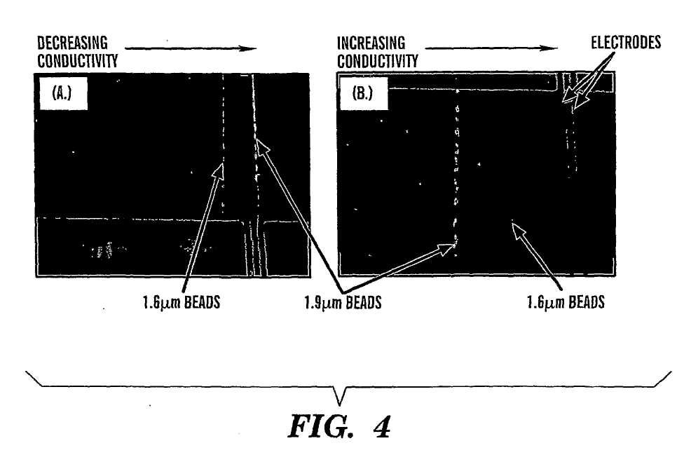

Here, Ks denotes (charge dependent) surface conductance and R represents the radius of the particle. For polystyrene particles with radii of order ˜1 μm or less, the surface conductance term will generally dominate the bulk conductivity at reasonably low ionic strengths. Accordingly, we see that decreasing the particle radius increases the conductivity. This is useful for device validation. In n-DEP operation, a smaller (and thus more highly conductive) particle will separate out earlier than a larger (and correspondingly less conductive) particle. By reversing the gradient's direction and performing a p-DEP based separation, the more highly conducting particle will now separate later than the larger, less conducting one. This behavior has been observed for particles with diameters of 1.60 μm and 1.90 μm (FIG. 4), and suggests that we are, in fact, separating by conductivity and not by size; the volumetric dependence of the DEP force would always lead to separation of larger particles (on which the DEP barrier force is greater) later than smaller ones. Sensitivity of the device to parameters other than particle size has also been investigated. Preliminary results suggest that the transduction between user-controlled “input” parameters such as frequency, flow rate, and media conductivity (upon which the DEP and drag forces are dependent) and particle IDP is highly sensitive and inherently tunable. Fractional changes in frequency of ˜20% can result in changes in the position of the IDP of ˜100 μm, enabling one to perform separations with a minimal amount of knowledge of the particle's dielectric properties a priori. Other aspects of the device's operation have been validated as well.

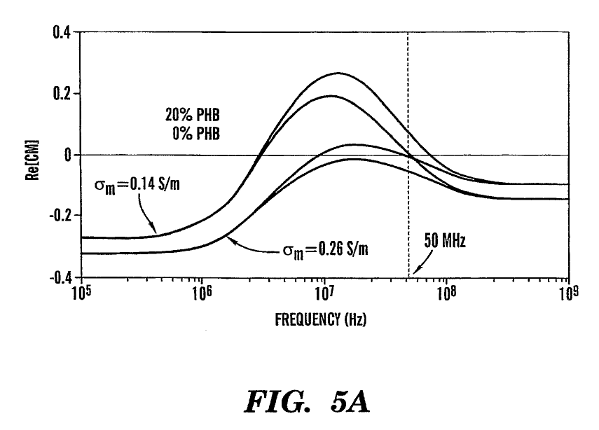

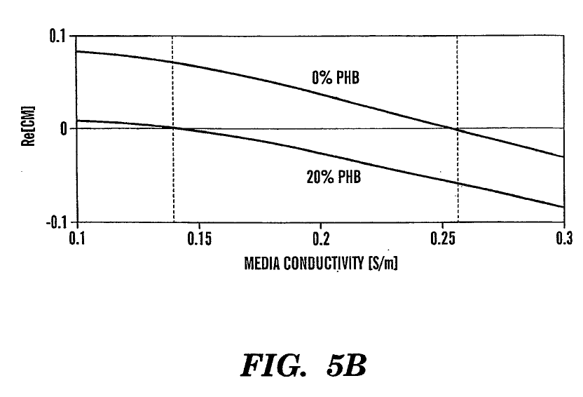

Plots of the CM factor illustrate how separation using an IDS device works. The CM factor, described in Equation 2, is a “lumped” complex number describing the interplay between the electrical properties of the medium and particle. FIG. 5A (blue lines) plots the calculated CM factor of bacteria as a function of frequency for two different solution conductivities (σₘ), using parameters obtained from literature (Suehero et al., J. Electrostatics 57:157-68 (2003)). We see that at frequencies <100 MHz the CM factor is quite different at the two solution conductivities. FIG. 5A shows (green lines) how that CM factor changes if the bacteria accumulates 20% PHB, assuming that the percent PHB linearly decreases the cytoplasmic conductivity and permittivity. In this example, a 20% concentration difference was used for illustrative purposes; it should not be taken as a measure of the IDS device's maximum sensitivity. At frequencies >10 MHz, the CM factors for the two strains differ from each other, and are both still affected by the solution conductivity.

To separate the two bacterial strains in a conductivity gradient, the IDS apparatus is operated at >10 MHz, where they have different CM factors (FIG. 5A), using media of varying conductivity. In FIG. 5B, the CM factor for those two strains is plotted when they are placed in a conductivity gradient at 50 MHz (though other frequencies can be used). The two strains experience no force at different media conductivities. The 20% PHB strain feels no force at πₘ=0.14 S/m, while the 0%-PHB strain feels no force at σₘ=0.26 S/m. Thus, if the two strains are placed in a microchannel with a spatial conductivity gradient and forced to their zero-force points, they will separate to different points along the width of that channel, which is how IDS works.

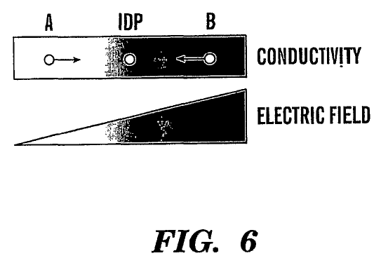

As described herein, to make a separation device the force field must drive the particle to its zero-force point, also called its iso-dielectric point. Thus, when the particle is in a region where the medium conductivity is too high, it should be pushed down the conductivity gradient, while if it is in a region where the media conductivity is too low it should be pushed up the conductivity gradient, analogous to the stability requirements for gradient separation methods. With reference to FIG. 6, this means that particle A should be pushed to the right and particle B to the left. Because at particle A's location its effective conductivity is greater than that of the medium, it experiences pDEP. Since particles experiencing pDEP are pulled up the electric-field gradient, the electric field should increase to the right in FIG. 6, as shown. Particle B, however, experiences NDEP, since the medium conductivity at that position is higher than the particle conductivity. Since particles experiencing nDEP are pushed down the electric-field gradient, the electric field should decrease from right to left, also consistent with the electric-field gradient as shown. Thus, the relative orientation of the conductivity and electric-field gradients depicted in FIG. 6 result in stable operation. Since the electric-field and conductivity gradients increase in the same direction, they are said to be in direct proportionality.

We have demonstrated our ability to create and characterize gradients of fluorescent liquids via optical and image processing techniques.

### REFERENCES

1. Grimm, S. The art and design of genetic screens: mammalian culture cells. Nat Rev Genet 5, 179-189 (2004).
2. Stephanopoulos, G. Metabolic fluxes and metabolic engineering. Metab Eng 1, 1-11 (1999).
3. Strohl, W. R. Biochemical engineering of natural product biosynthesis pathways. Metab Eng 3, 4-14 (2001).
4. Heida, T., Rutten, W. L. C. & Marani, E. Dielectrophoretic trapping of dissociated fetal cortical rat neurons. Ieee Transactions on Biomedical Engineering 48, 921-930 (2001).
5. Voldman, J., Toner, M., Gray, M. L. & Schmidt, M. A. A Microfabrication-Based Dynamic Array Cytometer. Analytical Chemistry 74, 3984-3990 (2002).
6. Wang, X. B., Huang, Y., Burt, J. P. H., Markx, G. H. & Pethig, R. Selective dielectrophoretic confinement of bioparticles in potential energy wells. Journal of Physics D (Applied Physics) 26, 1278-1285 (1993).
7. Fuhr, G. & Shirley, S. G. in Microsystem Technology in Chemistry and Life Science, Vol. 194 83-116 (Springer-Verlag Berlin, Berlin; 1998).
8. Pohl, H. A. & Crane, J. S. Dielectrophoresis of cells. Biophysical Journal 11, 711-727 (1971).
9. Markx, G. H., Talary, M. S. & Pethig, R. Separation of viable and non-viable yeast using dielectrophoresis. Journal of Biotechnology 32, 29-37 (1994).
10. Talary, M. S., Burt, J. P. H., Tame, J. A. & Pethig, R. Electromanipulation and separation of cells using traveling electric fields. Journal of Physics D (Applied Physics) 29, 2198-2203 (1996).
11. Huang, Y., Wang, X.-B., Becker, F. F. & Gascoyne, P. R. C. Introducing dielectrophoresis as a new force field for field-flow fractionation. Biophysical Journal 73, 1118-1129 (1997).
12. Markx, G. H., Pethig, R. & Rousselet, J. The dielectrophoretic levitation of latex beads, with reference to field-flow fractionation. Journal of Physics D (Applied Physics) 30, 2470-2477 (1997).
13. Gascoyne, P. R. C., Wang, X. B. & Vykoukal, J. A microfluidic device combining dielectrophoresis and field flow fractionation for partical and cell discrimination. Solid-State Sensor and Actuator Workshop, 37-38 (1998).
14. Wang, X.-B., Vykoukal, J., Becker, F. F. & Gascoyne, P. R. C. Separation of polystyrene microbeads using dielectrophoretic/gravitational field-flow-fractionation. Biophysical Journal 74, 2689-2701 (1998).
15. Yang, J., Huang, Y. & Gascoyne, P. R. C. Differential Analysis of Human Leukocytes by Dielectrophoretic Field-Flow-Fractionation. Biophysical journal 78, 2680 (2000).

All references described herein and throughout the specification are incorporated by reference in their entirety.

We claim:

1. An apparatus for analyzing particles comprising a fluid flow chamber containing
(a) at least a first inlet wherein fluid containing the particles to be separated can be introduced into the chamber;
(b) at least a second inlet wherein a second fluid with a different conductivity than the fluid containing the particles to be separated can introduced into the chamber;
(c) a mixer situated proximal to the first and second inlets, wherein the first and second fluids can be mixed to create a conductivity gradient;
(d) a spatially non-uniform electric field that creates a dielectrophoretic force positioned at an angle with respect to the flow of fluid through the chamber, wherein the dielectrophoretic force varies with fluid conductivity and directs the particles to a position where fluid electrical properties match the electrical properties of the particles, referred to as an isodielectric point (IDP); and
(e) outlets for fluid to exit the chamber.

2. The apparatus of claim 1, wherein the spatially non-uniform electric field is generated by at least two electrodes aligned along the length of the chamber at an angle with respect to the direction of fluid flow through the chamber, wherein a power supply is connected to said electrode(s) to apply a voltage signal to said electrode(s) to create a spatially non-uniform electric field which causes a dielectrophoretic force on the particles transiting through the channel.

3. The apparatus of claim 1, wherein the mixer is a multi-stage mixer and generates a conductivity gradient near the inlets of the channel.

4. The apparatus of claim 1, wherein the mixer is a diffusive mixer.

5. The apparatus of claim 4, wherein the diffusive mixer is a multi-stage diffusive mixer.

6. The apparatus of claim 1, wherein the mixer is a chaotic mixer or an electrokinetic instability mixer.

7. The apparatus of claim 1, wherein the electric field generates a negative dielectrophoretic force (n-DEP) on the particles, the fluid containing the particles to be separated is more polarizable than the second fluid, and the particles are propelled toward the field minima.

8. The apparatus of claim 1, wherein the electric field generates a positive dielectrophoretic force (p-DEP) on the particles, the fluid containing the particles to be separated is less polarizable than the second fluid, and the particles are propelled toward the field maxima.

9. The apparatus of claim 1, wherein the frequency of the applied voltage and the conductivity of the two fluids are controlled so that the particle's IDP is present at a point of release along the width of the chamber, such that when the particle reaches its IDP it is released from the DEP force exerted by the electric field, and flows to the corresponding outlet at the same position along the width of the channel, where it is collected.

10. The apparatus of claim 1, wherein the apparatus contains a third, fourth, fifth, or sixth inlet, wherein said inlets each comprise fluid that has a different conductivity than the fluid that contains the particles to be separated.

11. The apparatus of claim 10, wherein the particles to be separated are introduced in the first, second, third, fourth, fifth or sixth inlet.

12. A method for separating cells comprising:
(a) introducing a solution containing different cells into a particle sorting apparatus having a fluid flow chamber containing
(i) at least a first inlet wherein fluid containing the particles to be separated can be introduced into the chamber;
(ii) at least a second inlet wherein a second fluid with a different conductivity than the fluid containing the particles to be separated is introduced into the chamber;
(iii) a mixer situated proximal to the first and second inlets, wherein the first and second fluids can be mixed to create a conductivity gradient;
(iv) a spatially non-uniform electric field that creates a dielectrophoretic force positioned at an angle with respect to the flow of fluid through the chamber, wherein the dielectrophoretic force varies with fluid conductivity and directs the particles to a position where fluid electrical properties match the electrical properties of the particles, referred to as an isodielectric point (IDP); and
(v) outlets for fluid and cells to exit the chamber; wherein the solution containing the cells are introduced into the first inlet;
(b) subjecting the cells to the conductivity gradient and spatially non-uniform electric field as the cells traverse the chamber; and
(c) screening for cells based upon their IDP as the cells exit the chamber.

13. The method of claim 12, wherein the cells are screened by having outlets at specific positions based upon the IDP of the cells.

14. The method of claim 12, wherein the cells are collected as they exit the particle sorting apparatus.

15. The method of claim 12, wherein the IDP of the cells is known and the cells with the desired IDP are collected as they exit the particle sorting apparatus.

16. The method of claim 12, wherein the IDP of the cells is unknown and cells with varying IDPs are collected as they exit the particle sorting apparatus.

17. The method of claim 12, wherein cells to be screened comprise at least two populations of cells wherein one population of cells is selected based upon having a different IDP than the other population(s) of cells.

18. The method of claim 17, wherein the at least two populations of cells have different IDPs due to their expression of higher or lower levels of a particular protein.

19. The method of claim 17, wherein the at least two populations of cells have different IDPs due to the presence of a mutation in one protein in one population of cells that is absent in another population.

20. The method of claim 12, wherein the cells are collected in different fractions as they exit the chamber.

21. The method of claim 20, wherein at least one fraction of the collected cells are re-separated via a method comprising:
(a) introducing a solution containing the fraction of the collected cells into a particle sorting apparatus having a fluid flow chamber containing
(i) at least a first inlet wherein fluid containing the particles to be separated can be introduced into the chamber;
(ii) at least a second inlet wherein a second fluid with a different conductivity than the fluid containing the particles to be separated is introduced into the chamber;
(iii) a mixer situated proximal to the first and second inlets, wherein the first and second fluids can be mixed to create a conductivity gradient, wherein said conductivity gradient is narrower than the conductivity gradient used in the first separation;
(iv) a spatially non-uniform electric field that creates a dielectrophoretic force positioned at an angle with respect to the flow of fluid through the chamber, wherein the dielectrophoretic force varies with fluid conductivity and directs the particles to a position where fluid electrical properties match the electrical properties of the particles, referred to as an isodielectric point (IDP); and
(v) outlets for fluid and cells to exit the chamber; wherein the solution containing the cells are introduced into the first inlet;
(b) subjecting the cells to the conductivity gradient and spatially non-uniform electric field as the cells traverse the chamber; and
(c) screening for cells based upon their IDP as the cells exit the chamber.
